(19) United States
(12) Patent Application Publication
(10) Pub. No.: US 2018/0037102 A1
(43) Pub. Date: Feb. 8, 2018

(54) PROTECTIVE COVERING DEVICE

(71) Applicants: Jeffrey Douglas Wade, Medford, NY (US); Deanna Dolores Wade, Medford, NY (US); Thomas Vincent Sweeney, JR., Cranston, RI (US)

(72) Inventors: Jeffrey Douglas Wade, Medford, NY (US); Deanna Dolores Wade, Medford, NY (US); Thomas Vincent Sweeney, JR., Cranston, RI (US)

(21) Appl. No.: 15/469,562

(22) Filed: Mar. 26, 2017

Related U.S. Application Data
(60) Provisional application No. 62/372,256, filed on Aug. 8, 2016.

(51) Int. Cl. B60J 11/06; B60S 1/04

(52) U.S. Cl. CPC B60J 11/06; B60S 1/0491; H05B 2203/031

(57) ABSTRACT

A protective covering device is a line of insulated sheathes specially designed to be placed over the wiper blades of a vehicle while it is parked. An elongated, cylindrical tube, each protective covering device is internally fabricated of a durable foam rubber material to ensure optimal insulation potential, with a waterproof, Teflon-coated, or similar water resistant non-stick substance exterior to further prevent corrosion, sticking, and other damage. An alternate embodiment may provide an internal heating element, to keep ice and snow from forming on the elongated sheath, and at least one LED light attached thereon for use in low light level situations.

### CROSS-REFERENCE TO RELATED APPLICATION

The present application is related to and claims priority from prior provisional application Ser. No. 62/372,256, filed Aug. 8, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of protective covering devices and more specifically relates to a line of waterproof, weatherproof, non-stick, insulated sheathes specially designed for use in covering and protecting the wiper blades of a vehicle during cold weather conditions, as well as minimizing the time the wipers are exposed to such weather to prevent frost, snow, and ice from building up on and compromising the operation of wipers during inclement weather.

### 2. DESCRIPTION OF THE RELATED ART

Every day, millions of consumers climb into their automobiles and head off for a day of work, school, or recreation. Whether a busy executive traveling to an important business luncheon, a homemaker dropping the kids off at school, or a professional delivery man making his rounds; automobiles offer consumers a simple and efficient means of traveling from one destination to the next. During the winter months, driving one's car usually first involves scraping the vehicle windshield, and windows of accumulated frost, ice, or snow. Wiper blades that collect ice on them are often frozen to the windshield or beaten against the car windshield to have it removed, which can potentially damage both the windshield glass (i.e. crack it!) or the surface of the wiper blade can become pitted. This task is particularly common for the millions who live in apartments, condominiums, mobile homes, or houses which lack a covered garage, carport, or similar sheltered area in which to park their vehicle.

Further, parking one's car in the open air even for a few hours can result in the vehicle being covered in a thick blanket of ice or snow. Even after spending precious time laboriously scraping away snow and ice from the car, a motorist must still employ the windshield wipers to remove still-accumulating ice as well as to improve visibility if snow is still falling. Unfortunately, it is highly likely that the wipers and their blades are also encrusted with ice, rendering them practically useless. Not only can this obviously hinder a driver's visibility, which can lead to accidents, but prolonged exposure of the wiper blades to icy conditions can significantly reduce the operational integrity of the blades, resulting in costly replacement.

Various attempts have been made to solve the above-mentioned problems such as those found in U.S. Pat. No. 6,327,738 to Jeffrey S. Lewis; U.S. Publication. No. 2011/0192511 to William Charles Marrone; and U.S. Publication. No. 2014/0000772 to James E. Sparenberg. This art is representative of protective covering devices for windshield wipers. None of the above inventions and patents, taken either singly or in combination, is seen to describe the invention as claimed.

Ideally, a protective covering device should provide protection for windshield wipers from ice and snow and, yet would operate reliably and be manufactured at a modest expense. Thus, a need exists for a reliable protective covering device for windshield wipers to avoid the above-mentioned problems.

### BRIEF SUMMARY OF THE INVENTION

In view of the foregoing disadvantages inherent in the known protective covering device art, the present invention provides a novel protective covering device for windshield wipers. The general purpose of the present invention, which will be described subsequently in greater detail is to provide a line of waterproof, weatherproof, non-stick, insulated sheathes specially designed for use in covering and protecting the wiper blades of a vehicle during cold weather conditions, as well as minimizing the time the wipers are exposed to such weather to prevent frost, snow, and ice from building up on and compromising the operation of wipers during inclement weather.

A protective covering device for windshield wiper arms to protect against ice and snow is disclosed herein, comprising at least one elongated sheath member formed from an insulating material and having a central opening. The insulating material is formed from a foam rubber material, and an exterior coating formed from TEFLON or a similar water/ice resistant non-stick substance or material which is applied to the exterior surface of the protective covering device to prevent sticking and corrosion. The elongated sheath member is adapted to be placed upon a windshield wiper arm to protect against ice and snow build-up, and are sold in pairs. Each respective sheath member is adapted to cover one of two windshield wiper arms of an automobile.

The elongated sheath member further comprises electric defrost wiring attached along the length and adapted to conduct a low level electrical current to generate heat to prevent and remove ice or snow from attaching to the protective covering device. A battery member is attached thereto and adapted to provide the electric defrost wires with low level electrical current. Further, a switch member is attached thereto and adapted to selectively allow electrical current from the battery member to flow to the electric defrost wire.

The sheath member also has LED light members placed along the length of it, which are also connected to a battery, intended to project a source of light onto the windshield to allow an individual to see what snow or ice they need to remove from the windshield. This feature would be used in conditions where there is near zero visibility situations (a non-lit parking lot or a power outage). A switch is attached thereon and adapted to selectively allow electrical current from the battery to flow to the LED light member.

A storage pouch is provided which is adapted to store the elongated sheath members when not in use. The recommended procedure for storing the members is to remove them from each wiper arm after use, then place them on the automobile passenger floor mat and allow the heating system of the auto to dry them out. Once dry, they will be folded and placed into the storage pouch until their next use. The sheath member further comprises attachment members formed from hook and loop material, and in an alternate embodiment, a clasp-like O-ring device adapted to allow attachment to a windshield wiper member that would be squeezed to open as it is placed over the windshield wiper member, and once the cover is completely over the blade, the O-ring would be released and form a tight seal around the windshield wiper member such that strong winds cannot get up inside the protective covering device and blow it off the windshield wiper arm.

The present invention holds significant improvements and serves as a protective covering device for windshield wipers. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, protective covering device constructed and operative according to the teachings of the present invention.

FIG. 1 shows a perspective view illustrating a protective covering device in an in-use condition according to an embodiment of the present invention.

FIG. 2 is a right side view illustrating a protective covering device having a hook and loop material enclosure according to an embodiment of the present invention of FIG. 1.

FIG. 3 is a left side view illustrating protective covering device having a clasp-like O-ring device enclosure according to an embodiment of the present invention of FIG. 1.

FIGS. 4A and 4B are perspective views illustrating the receiving end of a protective covering device and a storage pouch respectively, according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a protective covering device and more particularly to a line of waterproof, weatherproof, non-stick, insulated sheathes specially designed for use in covering and protecting the wiper blades of a vehicle during cold weather conditions, as used to minimize the time the wipers are exposed to such weather to prevent frost, snow, and ice from building up on and compromising the operation of wipers during inclement weather.

Generally speaking, protective covering device for windshield wipers are a line of insulated sheathes specially designed to be placed over the wiper blades of a vehicle while it is parked. An elongated, cylindrical tube, each protective covering device is internally fabricated of a durable foam rubber material to ensure optimal insulation potential, with a waterproof, Teflon-coated exterior, or a similar water resistant substance or material to further prevent corrosion, sticking, and other damage. In addition, each protective covering device includes a snap closure made of a flexible plastic or metal material that is able to withstand the elements. Protective covering device would be made available in a variety of sizes to accommodate most wiper configurations. The protective covering device is able to slide directly over an auto's wiper assembly, sufficiently covering the entire blade and arm of the unit. During cold or hazardous weather, a user would elevate the windshield wiper assembly off of the windshield to a standing position and then place a protective covering device over each wiper, before entering the house or building. A user can leave the protective covering device in place until ready to drive again. When the user is ready to drive again, the protective covering device would simply be removed, and the wipers would be positioned to once again have contact with the windshield to be able to work as normal.

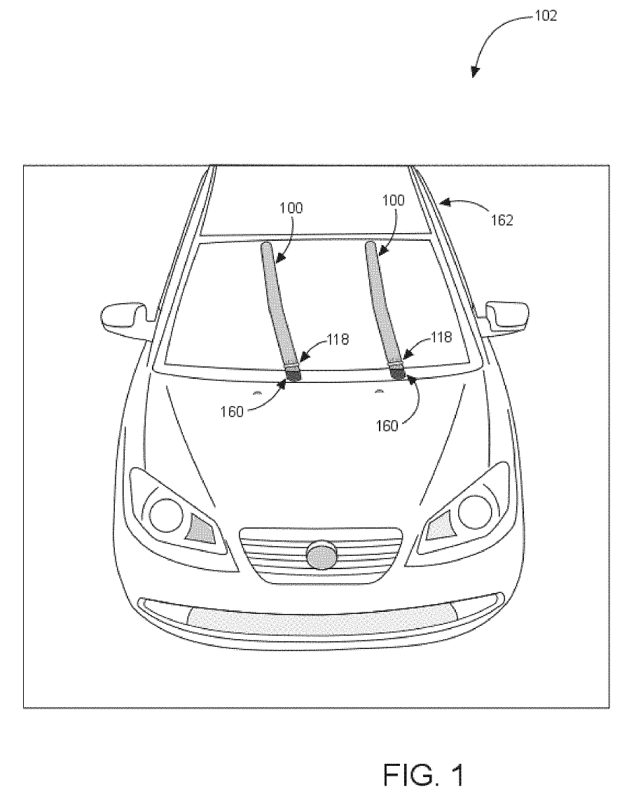

Referring to the drawings by numerals of reference there is shown in FIG. 1, a perspective view illustrating a protective covering device 100 in an in-use condition 102 according to an embodiment of the present invention.

Protective covering device 100 for windshield wiper arms 160 to protect against ice and snow is disclosed herein, comprising at least one elongated sheath member 106 formed from insulating material 108 and having central opening 110. Insulating material 108 is formed from a foam rubber material, and exterior coating 114 formed from TEFLON or a similar coating is applied to exterior surface 116 of protective covering device 100 to prevent sticking and corrosion. Elongated sheath member 106 is adapted to be placed upon a windshield wiper arm 160 to protect against ice and snow build-up, and are sold in pairs. Each respective elongated sheath member 106 is adapted to cover one of two windshield wiper members 160 of a vehicle 162.

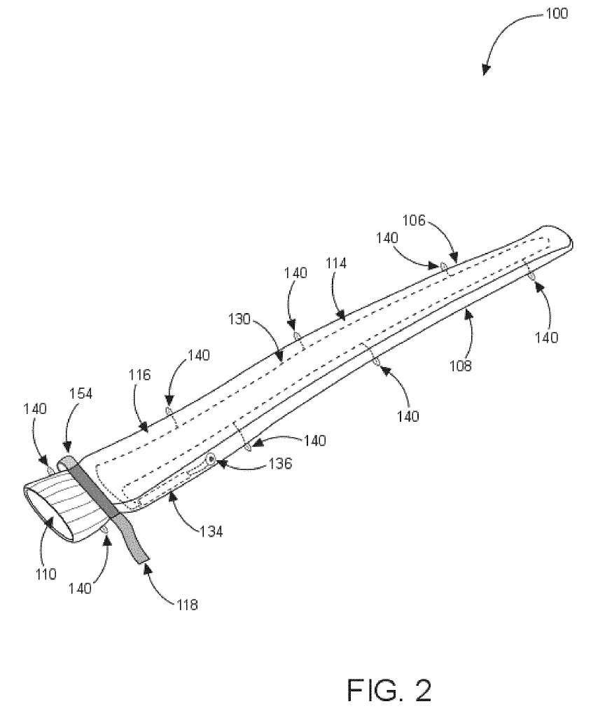

Referring now to FIG. 2, a right side view illustrating a protective covering device 100 having a hook and loop material 154 enclosure according to an embodiment of the present invention.

Elongated sheath member 106 further comprises electric defrost wire 130 attached along the length and adapted to conduct a low level electrical current to generate heat to prevent and remove ice or snow from attaching to protective covering device 100. Battery member 134 is attached thereto and adapted to provide electric defrost wire 130 with low level electrical current. Further, switch member 136 is attached thereto and adapted to selectively allow electrical current from battery member 134 to flow to electric defrost wire 130.

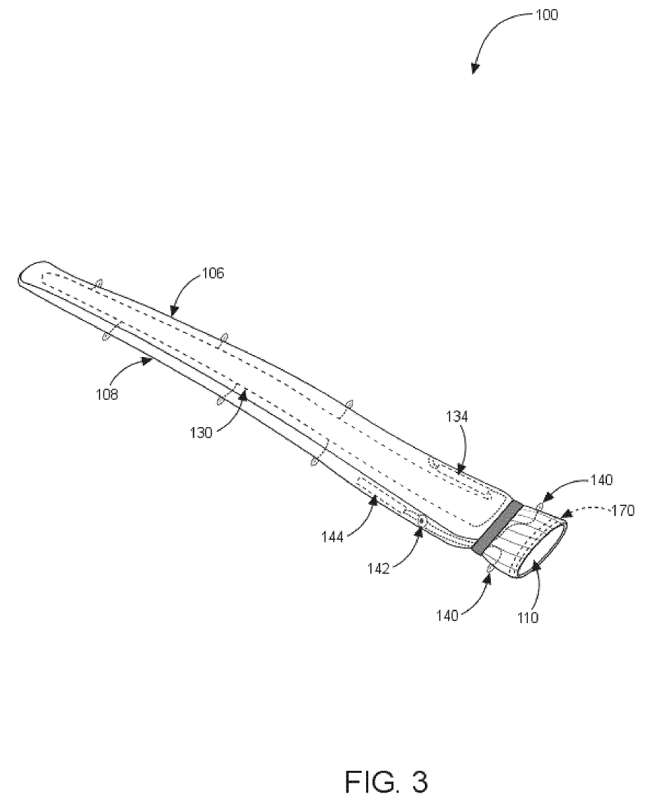

Referring now to FIG. 3, a left side view illustrating protective covering device 100 having a clasp-like O-ring device 170 enclosure according to an embodiment of the present invention.

Elongated sheath member 106 also has at least one LED light member 140, which is also connected to battery 144, and adapted to provide better visibility when applying protective covering device 100 to a windshield wiper member 160. Switch 142 is attached thereon and adapted to selectively allow electrical current from battery 144 to flow to LED light member 140.

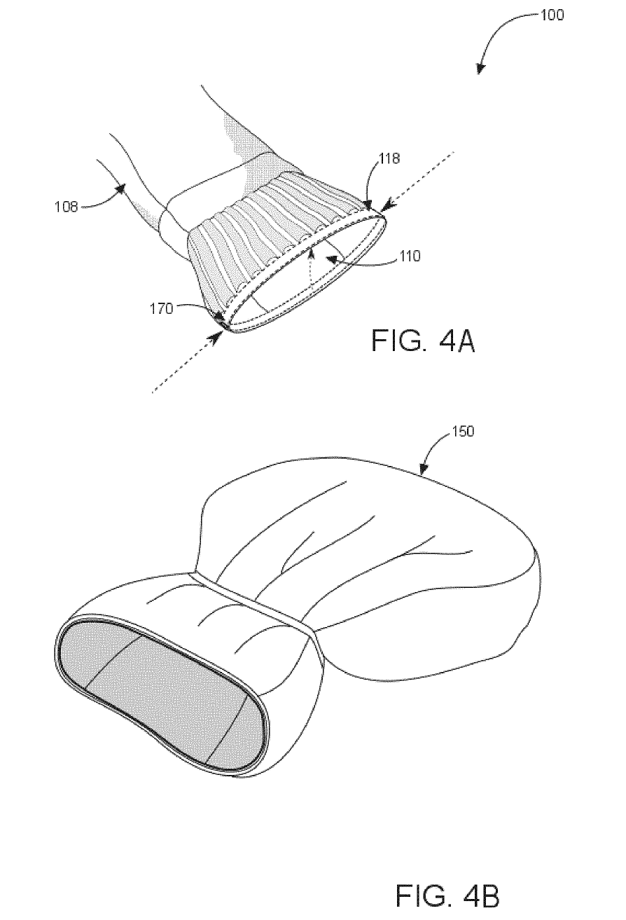

Referring now to FIGS. 4A and 4B, perspective views illustrating the receiving end of a protective covering device 100 with a clasp-like O-ring device 170 and a storage pouch 150 respectively, according to an embodiment of the present invention.

Storage pouch 150 is provided which is adapted to store elongated sheath members 106 when not in use. Storage pouch 150 is formed from a material chosen from a list of materials consisting of plastic and nylon. Elongated sheath member 106 further comprises attachment members 118 formed from hook and loop material 154, and alternately clasp-like O-ring device 170 adapted to allow attachment to windshield wiper member 160 when the sides are pressed toward the middle.

Protective covering device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A protective covering device for windshield wiper arms to protect against ice and snow, comprising:
at least one elongated sheath member including:
a central opening therethrough;
wherein said elongated sheath member is formed from an insulating material; and
an exterior coating applied to an exterior surface thereof adapted to prevent corrosion thereof;
wherein said elongated sheath member is adapted to be placed upon a length of a windshield wiper arm to protect against ice and snow build-up thereon;

2. A protective covering device of claim 1, wherein said exterior coating is formed from TEFLON or a similar non-stick coating.

3. A protective covering device of claim 1, wherein said insulating material is formed from a foam rubber material.

4. A protective covering device of claim 1, wherein there are two said elongated sheath members, and wherein each respective sheath member is adapted to cover a respective one of two windshield wiper arms of a vehicle.

5. A protective covering device of claim 1, wherein said sheath member further comprises electric defrost wiring attached along an internal length thereof and adapted to conduct a low level electrical current therethrough to generate heat to prevent and remove ice or snow from attaching to the protective covering device.

6. A protective covering device of claim 5, wherein said sheath member further comprises a battery member attached thereto and adapted to provide said electric defrost wiring with said low level electrical current.

7. A protective covering device of claim 6, wherein said sheath member further comprises a switch member attached thereto and adapted to selectively allow electrical current from said battery member to flow to said electric defrost wiring.

8. A protective covering device of claim 7, wherein there are two said elongated sheath members, and wherein each respective sheath member is adapted to cover a respective one of two windshield wiper arms of a vehicle.

9. A protective covering device of claim 1, wherein said sheath member further comprises at least one LED light member attached thereto adapted to provide better visibility in low or zero light conditions so the driver can see what snow/ice they need to remove from the windshield.

10. A protective covering device of claim 9, wherein said sheath member further comprises a battery member attached thereto and adapted to provide said at least one LED light member with electrical current.

11. A protective covering device of claim 10, wherein said sheath member further comprises a switch member attached thereto and adapted to selectively allow electrical current from said battery member to flow to said at least one LED light member.

12. A protective covering device of claim 1, further comprising a storage pouch adapted to store both elongated sheath member therein.

13. A protective covering device of claim 13, wherein said waterproof liner member is formed from a material chosen from a list of materials consisting of plastic and nylon.

14. A protective covering device of claim 10, wherein said sheath member further comprises attachment members thereon adapted to allow releasable attachment to a windshield wiper member.

15. A protective covering device of claim 10, wherein said attachment members are formed as clasp-like O-ring devices.

16. A protective covering device of claim 10, wherein said attachment members are formed from hook and loop material.
